(19) United States
(12) Patent Application Publication
(10) Pub. No.: US 2011/0019805 A1
(43) Pub. Date: Jan. 27, 2011

(54) METHODS AND SYSTEMS FOR SEARCHING AUDIO RECORDS

(75) Inventor: Paul William Zoehner, Coquitlam (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: ALGO COMMUNICATION PRODUCTS LTD., Burnaby, BC (CA)

(21) Appl. No.: 12/812,786

(22) PCT Filed: Jan. 14, 2009
(86) PCT No.: PCT/CA2009/000039

§ 371 Date: Sep. 24, 2010

Related U.S. Application Data
(60) Provisional application No. 61/020,984, filed on Jan. 14, 2008.

(51) Int. Cl. G10L 15/00; H04M 11/00

(52) U.S. Cl. 379/90.01; 704/237; 704/E15.001

(57) ABSTRACT

Methods and systems are provided for searching audio records. Certain embodiments of the invention may be applied to search audio records containing a user's voice for instances where a specific sound, such as a word or phrase, is vocalized by the user. An audio sample is provided by recording the user vocalizing the sound. The audio sample is compared with the audio records to locate matches to the audio sample. In some embodiments, the audio records comprise recordings of calls between a near-end caller and a far-end caller, and the audio sample is a recording of a sound spoken by the near-end caller. The same input device may be used to record both the audio sample and the audio records.

### CROSS-REFERENCE TO RELATED APPLICATIONS

This application claims priority from U.S. patent application No. 61/020,984 filed 14 Jan. 2008 and entitled METHODS AND SYSTEMS FOR SEARCHING AUDIO RECORDS. For the purposes of the United States of America, this application claims the benefit under 35 U.S.C. §119 of U.S. patent application No. 61/020,984 filed 14 Jan. 2008 and entitled METHODS AND SYSTEMS FOR SEARCHING AUDIO RECORDS which is hereby incorporated herein by reference.

### TECHNICAL FIELD

This invention relates to methods and systems for searching collections of audio records.

### BACKGROUND

Audio recording systems may be used to create audio records of conversations and other forms of speech vocalized by one or more individuals. For example, audio recording systems may be applied to record telephone calls so that recorded calls may later be reviewed for monitoring, quality assurance, record-keeping, investigations and other purposes. Audio recording systems may also be applied to record court proceedings, interviews, speeches, presentations, lectures, plays, readings and the like. In any of these applications, audio recording systems may generate substantial volumes of audio records.

Searching for a particular audio record in a large collection of audio records is often a challenging task. One method of searching audio records containing speech is to transcribe all of the audio records and to perform a text search of the transcript. Another method of searching audio records is to play back all of the audio records and to listen to them for the desired audio record. These methods may be time consuming or impractical to implement.

There is a general desire for efficient and reliable methods and systems for searching audio records which may be applied to large volumes of audio records to find a particular record of interest.

### BRIEF DESCRIPTION OF DRAWINGS

In drawings which illustrate non-limiting embodiments of the invention,

FIG. 1 is a flowchart illustrating a method of conducting a search of audio records according to an embodiment of the invention;

FIG. 2 is a flowchart illustrating a specific implementation of the method shown in FIG. 1;

FIG. 3 is a flowchart illustrating a method of creating an audio sample which may be used in the method shown in FIG. 1 or 2;

FIG. 4 is a data flowchart illustrating a method of conducting a search of audio records according to an embodiment of the invention;

FIG. 5 schematically depicts the components of a system according to one embodiment of the invention;

FIG. 6 schematically depicts the components of a recorder and searcher subsystem which may be used in the system shown in FIG. 5; and

FIG. 7 schematically depicts the data in an audio repository which may be used in the system shown in FIG. 5.

### DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

This invention provides methods and systems for identifying audio records of interest from a repository of audio records. Certain embodiments of the invention may be applied to search audio records containing a user's voice for instances where a specific sound, such as a word or phrase, is vocalized by the user. An audio sample is provided by recording the user vocalizing the sound to be located in the audio records. The user may optionally use the same input device (e.g. handset, microphone, etc.) to record both the audio sample and the audio records. The audio sample is then compared with the audio records (or a subset of the audio records) to locate potential matches. Certain embodiments of the invention determine one or more correlation values for each audio record. A high correlation value indicates a strong match to the audio sample, and conversely, a low correlation value indicates a weak match to the audio sample.

The audio records may be sorted. Sorting may be based on one or more of the following, for example: maximum correlation value of an audio record, number of portions of an audio record having a correlation value above a threshold value, date, far-end caller number, etc. A list of relevant audio records may be provided. Selected audio records may be played by the user. The user may listen to these audio records to determine whether they contain the word or phrase of interest. The search results and parameters may be stored for archival purposes and future reference.

It can be seen that in certain embodiments described above, an audio sample of the user's voice is compared with audio records also containing that user's voice. The same input device may be used to record the user's voice for the audio sample and the audio records. Therefore, the methods and systems described herein may be applied to search audio records to find good matches to a specific word or phrase regardless of the language, dialect, accent, pitch, tone, or individual voice characteristics. Such methods and systems may locate more precise matches, and in a more efficient manner, than in other kinds of searches in which dissimilar speaking voices are compared to one another, or in which different input devices are used for recording the audio records and the audio sample.

Particular embodiments of the invention may be applied to search audio records which comprise calls between a near-end (local) caller and a far-end (remote) caller, as recorded by a call recording system. Large volumes of audio records representing months or years of recordings may accumulate as digital or analog data in an audio repository. There may be occasions where it is desirable to locate audio records of interest from the repository. In certain embodiments of the invention, the audio records are searched for instances where a particular word or phrase is spoken by the near-end caller. An audio sample is generated by recording the near-end caller speaking the particular word or phrase of interest into an input device. The audio sample is then compared with the audio records to locate audio records of interest. As will be appreciated by one of skill in the art, the methods and systems described herein are not restricted to use with call recordings, but may be applied to search audio records containing other kinds of speech or sounds, such as legal or administrative proceedings, discussions, interviews, speeches, presentations, lectures, plays, readings, etc.

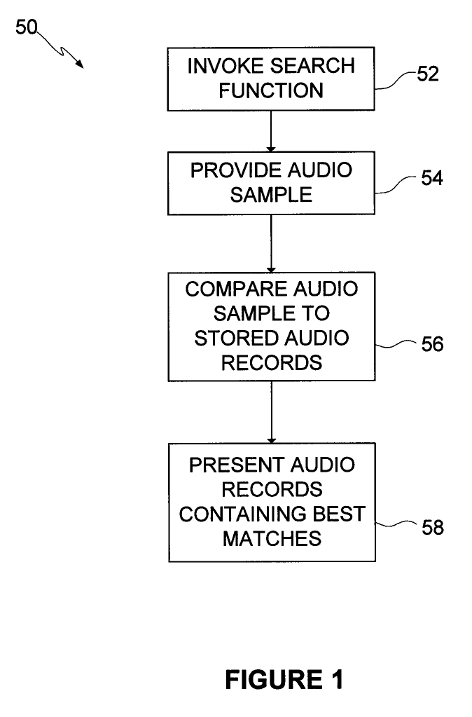

FIG. 1 illustrates a method 50 of searching audio records for instances where a specific word, phrase or other sound is vocalized by a user. Method 50 begins by invoking a search function at block 52. An audio sample is provided at block 54. The audio sample is provided by recording the user vocalizing the word, phrase or other sound of interest. The audio sample is compared with the audio records at block 56, and the audio records which represent the best matches to the audio sample are presented at block 58. In some embodiments, more than one audio sample with different sounds may be provided for comparison with the audio records. The comparison may determine whether there are audio records having matches to one, or a plurality, or all of the audio samples provided.

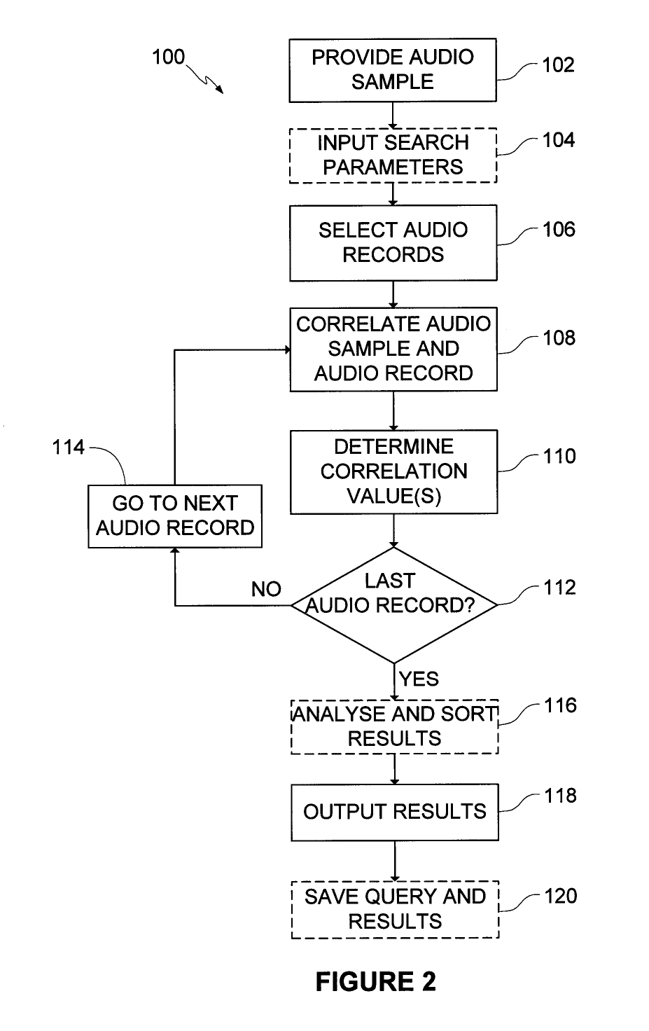

FIG. 2 shows a method 100 which is a specific implementation of the method illustrated in FIG. 1. Method 100 begins at block 102 by receiving an audio sample containing a word, phrase or other sound spoken by the user. In some embodiments, the user is a near-end caller and the audio records are recordings of calls between the near-end caller and a far-end caller. As will be explained in further detail below, the audio sample may be provided by recording a near-end caller vocalizing the word, phrase, or other sound of interest. This may be accomplished by having the near-end caller speak into the receiver of a call handset which is connected to a call recording system. In some embodiments, this call handset is also the same handset used by the near-end caller in generating the call records. In another embodiment, the audio sample may be provided by recording the near-end caller speaking into a receiver of another handset or other microphone device.

The audio sample may be recorded and stored on a suitable storage medium so that the audio sample may later be supplied for the search described in method 100. Multiple audio samples containing different sounds of interest may be recorded and stored for future searches.

Search parameters are optionally supplied at block 104 to restrict the extent of the audio records to be searched. Where the audio records are call recordings, the search may be restricted to calls having one or more of the following parameters, for example:

calls recorded within a specified date or time range;

calls of a particular type (e.g. incoming or outgoing);

calls to or from a specified line number (e.g. call display information);

calls having a specified minimum or maximum duration; and

call records having specified user-provided comments or other data tags.

The search may also be restricted to particular parts of audio records, such as the first minute or last minute of calls. The search parameters are applied at block 106 to select the audio records or parts of audio records to be searched. If no search parameters are specified, predefined default search parameters may be applied to select the audio records to be searched, or all of the audio records may be selected at block 106 for the search.

Method 100 proceeds to block 108, where the audio sample is correlated with a first audio record to determine whether there are any potential matches to the audio sample within the audio record. The correlation may be performed by hardware or software components, using known digital signal processing (DSP) analysis and methods. Correlation may be performed by comparing the audio sample with incrementally sliding (time-shifted) portions of the audio record which are approximately the same length as the audio sample. The correlation techniques may allow for differences between the audio sample and audio record portions in tone, speed, volume, inflection, and the like. At block 110, correlation results in a determination of one or more correlation values for audio record portions which are indicative of the degree of similarity between the audio sample and the audio record portions. For the audio record portions having a correlation value above a certain threshold, the position of each portion in the audio record and its associated correlation value(s) may be stored in memory so that these audio portions can later be retrieved or accessed.

After obtaining the one or more correlation values, method 100 determines at block 112 whether there are further audio records to be correlated with the audio sample. If the previously correlated audio record is not the last audio record to be searched, the next audio record is retrieved at block 114, and the steps at blocks 108 and 110 are repeated for this particular audio record. The sequence in which audio records are searched may be determined by audio record timestamps (e.g. the search may proceed chronologically), file location (e.g. the search may proceed from the first data storage location to the next in an audio repository), audio record duration (e.g. the search may proceed starting with the longest audio record, and end with the shortest audio record), or another characteristic.

The steps at blocks 108 and 110 are not necessarily performed on the audio records serially. For example, some embodiments may have hardware which permits the correlation analysis to be performed on multiple audio records or parts of audio records simultaneously.

The correlation results may be analysed at block 116. In some embodiments, a relevance rating is assigned to each audio record. The relevance rating may be based, for example, on the highest correlation value of all audio portions of the audio record. Alternately, it may be based on the number of audio portions in the audio record which have a correlation value above a certain threshold value. The audio records may be sorted by their relevance rating, date, far-end caller number, etc. Other kinds of analysis may be performed at block 116.

At block 118, search results are output in some form. For example, the results may be graphically displayed or printed, or communicated aurally. The results may include a listing of all audio records having correlation values above a certain threshold value. The threshold value may be selectable by the user. In certain embodiments, a suitably high threshold value is defined so that only very close matches to the audio sample are listed. If the audio records are assigned a relevance rating, the audio records may be listed in order of decreasing or increasing relevance. A user may selectively play back audio recordings or portions of audio recordings that are listed. In certain embodiments, the user may play back the audio recordings by providing commands using a telephone keypad or a computer interface or orally through a telephone handset. The results and search parameters may be stored for future reference at block 120.

The audio sample provided at block 102 may be supplied by recording a near-end caller speaking into the receiver of the same call handset that is used in generating the audio records. Use of the same handset (or the same microphone) to provide the audio sample and audio records advantageously avoids variations in volume, noise, pitch, etc. attributable to differences between microphones of hand sets or other devices, which may hinder a search for precise matches to an audio sample.

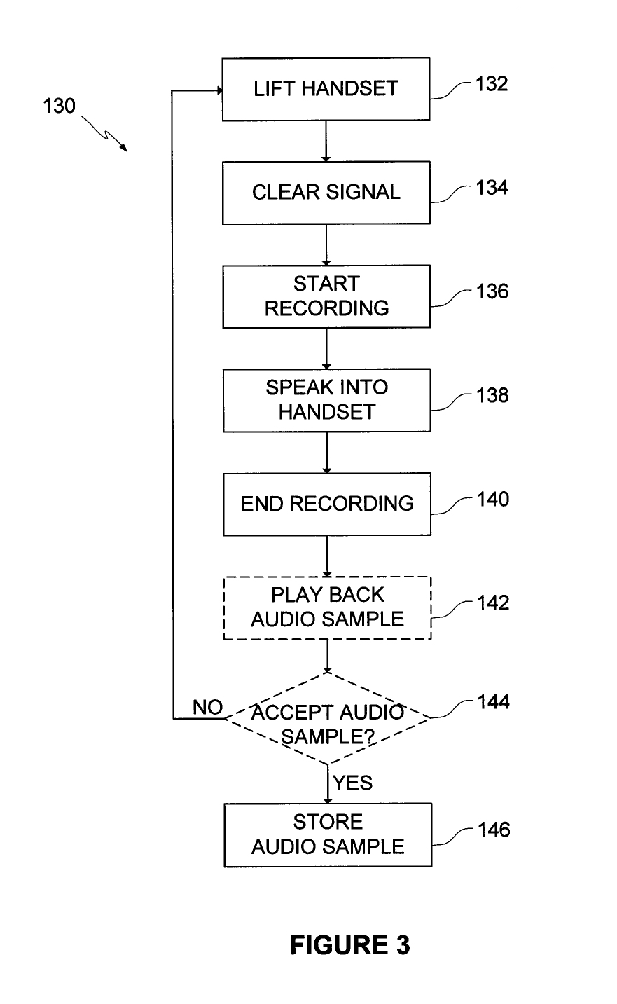

FIG. 3 shows a method 130 for generating an audio sample with a handset. Method 130 is described herein as an example of a method for generating an audio sample. As appreciated by one of skill in the art, other suitable methods for generating an audio sample may be implemented for use in the embodiments of the invention described herein. Method 130 begins at block 132 with the near-end caller lifting the handset (or otherwise placing it off-hook). At block 134, the near-end caller ensures that the signal in the line is clear. In standard telephones, the dial tone which is heard when the telephone is off-hook may be cleared by pressing any key on the telephone keypad. After the line is cleared, recording of the audio sample is commenced at block 136. The near-end caller speaks a word or phrase into the handset at block 138, and recording is subsequently stopped at block 140.

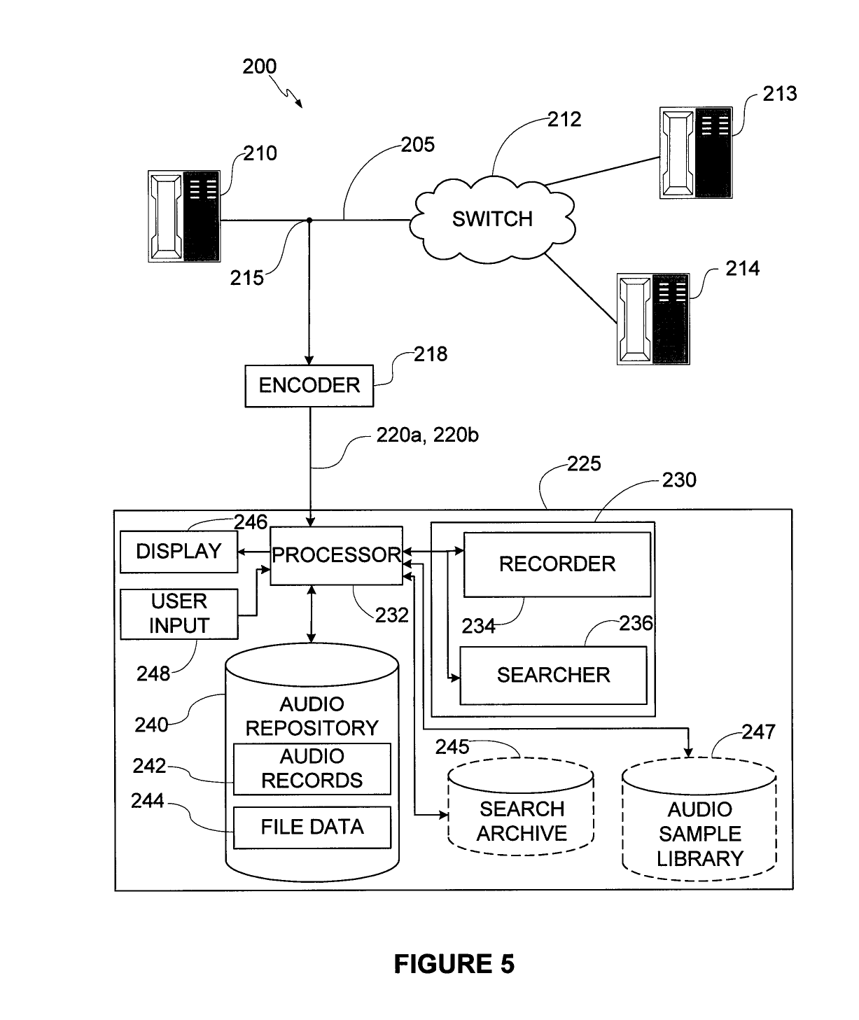

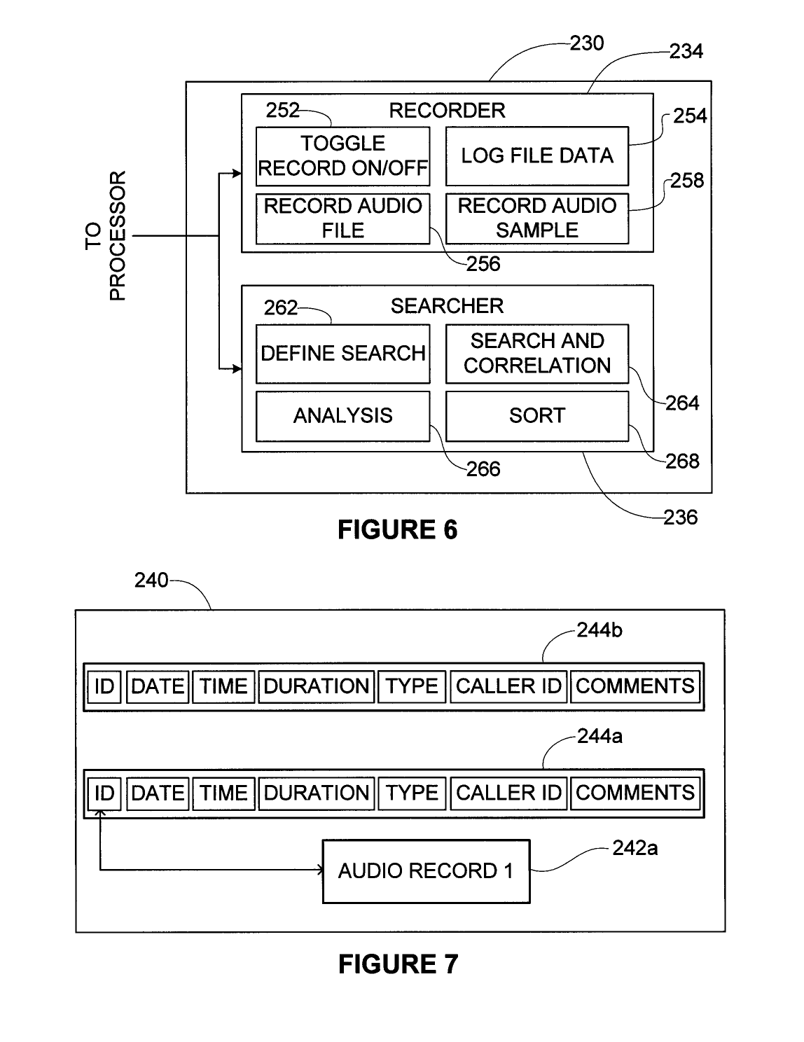

The start and stop of recording may be triggered by the occurrence of certain events. For example, in some embodiments the recorder may be programmed such that after the near-end caller lifts the handset at block 132, and presses a certain key on the keypad (which also clears the signal on the line for block 134), the recorder detects that the key has been pressed and beings recording. The recorder may be programmed to end recording as soon as another event occurs, such as a certain key being pressed on the key pad or the handset being replaced. Recording is explained in further detail below, with reference to FIGS. 5 and 6.

After recording of the audio sample has ended at block 140, the near-end caller or user may have the option of playing back the audio sample, at block 142, and deciding whether to accept the audio sample as recorded, at block 144. If the near-end caller or user rejects the audio sample, steps 132 to 140 may be repeated to generate another audio sample. Otherwise, as shown at block 146, the audio sample is stored on a storage medium for later use in a search of audio records.

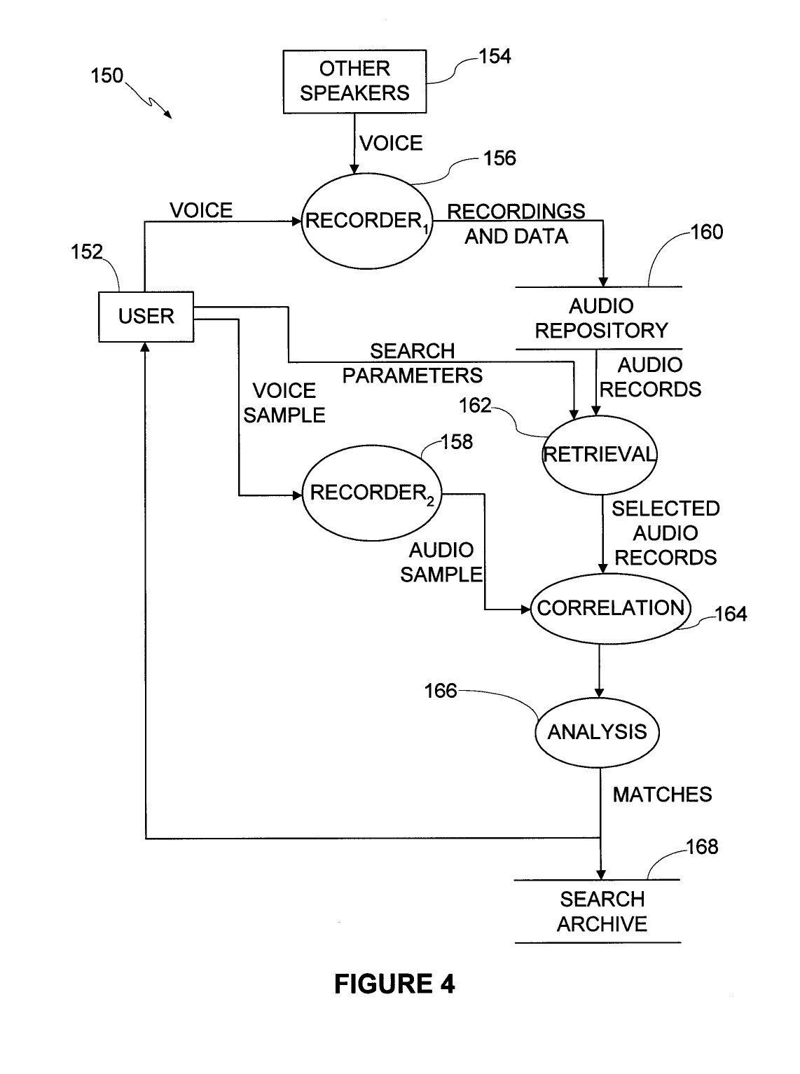

FIG. 4 illustrates the flow of data through a system 150 according to one embodiment of the invention. In the illustrated embodiment, user 152 engages in conversation with other speakers 154, and their conversations are recorded by a first recording subsystem 156. Recording subsystem 156 generates recordings and data about the recordings that are then stored in an audio repository 160. If user 152 converses with speakers 154 by telephone, recording subsystem 156 may be a call recording subsystem such as one which is described below with reference to FIG. 5.

User 152 may interact with components of system 150 to search for recordings in audio repository 160. For example, user 152 may wish to locate a recording of a conversation with a company service representative in which the representative provided a cost estimate to user 152 for a move. User 152 recalls that he would have spoken the words “Vancouver” and “Ottawa” to the representative, given that the move was between these cities. Therefore, to help locate this particular recording, user 152 may provide audio samples of the words “Vancouver” and “Ottawa”. This may be accomplished by a second recording subsystem 158, which records user 152 speaking the words “Vancouver” and “Ottawa” into an input device and generates a separate audio sample for each word. In some embodiments, recording subsystems 156 and 158 may be the same recording subsystem, and the same input device (e.g. call handset) may be used by user 152 to generate the audio samples and recordings.

User 152 further recalls that the conversation took place between four to six weeks ago. Therefore, to facilitate the search, user 152 may provide search parameters to limit the search to recordings within the time frame of interest. These search parameters are applied by a retrieval subsystem 162 which retrieves selected audio records from audio repository 160 that meet the specified parameters.

Correlation subsystem 164 correlates the audio samples with the selected audio records to determine correlation values for the audio records, such as a first correlation value indicative of a degree of similarity to the word “Vancouver”, and a second correlation value indicative of a degree of similarity to the word “Ottawa”. At analysis subsystem 166, the correlation results are analysed. For example, audio records which have both first and second correlation values above a predefined threshold value may be selected for output to user 152. If the threshold value is set appropriately high, there is a good chance that the audio records selected for output contain instances of user 152 speaking both the words “Vancouver” and “Ottawa”. User 152 may play back these audio records via an audio playback subsystem to determine whether the records contain the conversation of interest. In some embodiments, user 152 may play back specific parts of an audio record which contain the matches to the one or more audio samples. The audio records may be played back to user 152 through the same handset which is used to generate the audio samples and recordings. User 152 may store, save, or send (e.g. by email) audio records of interest so that they can later be reviewed without repeating the entire search. Search results, such as audio records identified to be of interest, may be stored in a search archive 168.

FIG. 5 shows a system 200 for generating audio records and conducting a search of the audio records for a match to an audio sample, where the audio records comprise call records. System 200 has a near-end telephone 210 which is connected to a telephone switch 212 by an analog or digital telephone line 205. Switch 212 may be part of the public switched telephone network (PSTN), an Internet Protocol-based network, or other network which switches and routes calls between callers. Conversations may be carried out between a near-end caller at near-end telephone 210 and a far-end caller at far-end telephone 213 or 214.

System 200 has a wire tap 215 which taps into line 205 to observe signals traveling on line 205. The observed signals are passed through an encoder 218 which converts them into a form that may be read by a processor 232 of an audio recording subsystem 225. If line 205 is analog, encoder 218 may include an analog-to-digital converter (ADC) to digitize the signals. The digital signals are then encoded by encoder 218 into a suitable audio format. In some embodiments, encoder 218 may have a codec which encodes the digitized signals onto an audio channel conveying digital audio data and a data channel conveying signaling information such as off-hook, on-hook, caller identification, and message waiting. In the illustrated embodiment, digital signals from wire tap 215 are encoded by encoder 218 onto an audio USB channel 220a which conveys the conversation carried out between the near-end caller and far-end caller and a data USB channel 220b which conveys signaling information. Channels 220a, 220b are connected to a USB port at processor 232. In other embodiments, other kinds of encoding and interface standards may be used to relay the signals observed on line 205 to audio recording subsystem 225.

In still other embodiments, the signals on line 205 may be relayed in analog or digital form directly to encoder 218 thereby obviating the need for a wire tap 215. For instance, near-end telephone 210 may be an IP telephone which sends an audio stream to encoder 218 which is a copy of the audio stream received by and transmitted from near-end telephone 210 on line 205.

Audio recording subsystem 225 records and logs calls originating from or received by near-end telephone 210. More particularly, audio recording subsystem 225 has a recorder 234 which provides instructions to processor 232 to process the information received on channels 220a, 220b so that calls between a near-end caller and far-end caller on telephone line 205 are recorded and information about each call (date, time, duration, type, caller identification, etc.) is logged. This data may be stored in an audio repository. In the illustrated embodiment, audio repository 240 stores audio records 242 which contain the calls recorded by recorder 234, and file data records 244 which contain information (i.e. meta-data) logged by recorder 234 about each call. Audio records 242 may be stored as uncompressed wave files, or in a compressed format such as wma, mp3, or aac, for example.

Recorder 234 may be implemented as hardware for performing the recording of audio signals (e.g. which may include hardware in encoder 218), and as software which provides instructions to processor 232 for processing information received on channels 220a, 220b. Recorder 234 may include various functions for recording calls and logging call data on line 205. For example, in the illustrated embodiment of FIG. 6, call recorder 234 includes a “toggle record on/off” function 252 that determines when to begin and end recording. Function 252 may initiate recording whenever a certain event occurs (e.g. near-end telephone 210 is taken off-hook, or user manually toggles a record “on” button), and may terminate recording whenever another event occurs (e.g. near-end telephone is placed on-hook, or user manually toggles a record “off” button). A “record audio file” function 256 records the conversation on line 205 occurring between the time that recording is initiated and terminated. A “record audio sample” function 258 generates the audio sample to be matched against the audio records. In some embodiments, the audio sample may be generated using a handset of the near-end caller, and function 258 may determine when to start and stop recording an audio sample from the handset, such as in the manner described above with respect to method 130 (FIG. 3). Call information, such as date, time, duration of call, type of call (e.g. incoming, outgoing, missed call), and caller ID number is logged by a “log file data” function 254, and may be associated with a particular call recording. The various functions of recorder 234 may be provided by an ECR Enterprise Call Recorder™, a digital or analog AuxBox™ and CCR Client Call Recorder™ software, available from Algo Communication Products Ltd.

Audio recording subsystem 225 also has a searcher 236 for searching audio records for a match to one or more audio samples. Searcher 236 provides instructions to processor 232 for searching audio repository 240. Searcher 236 may be implemented as software, hardware, or a combination thereof. In the illustrated embodiment of FIG. 6, searcher 236 has various functions, such as a “define search” function 262, which accepts search parameters and applies such parameters to the audio repository to define a portion of audio repository 240 (e.g. selected audio records) to be searched. A “search and correlation” function 264 correlates the audio sample with the audio records to determine correlation values indicative of the degree of similarity between the audio sample and portions of the audio records. An “analysis” function 266 analyses the correlation values of the audio records, and may compare these values to one or more threshold values and assign a relevance rating to each audio record based on the correlation values. A “sort” function 268 sorts the audio records by relevance, date, far-end caller number, etc.

As shown in FIG. 5, a search archive 245 may be provided in audio recording subsystem 225 to store search queries, search parameters and search results, for future reference, reuse or call categorization. A library of audio samples containing words or phrases of interest may be created for particular users and stored in audio sample library 247. Audio samples of interest may be retrieved from library 247 for conducting the search and correlation of selected audio records.

Selected audio samples from library 247 may be used to monitor conversations for key words or phrases. For example, audio samples containing the words “complaint”, “threat”, and “warning” as spoken by a call agent may be prerecorded and stored in library 247. Searcher 236 may be programmed to search audio records featuring that call agent for matches to these audio samples. Audio records containing a match can be flagged.

While certain software functions are identified above by way of example, it will be appreciated by one of skill in the art that other functions may be implemented by recorder 234 and searcher 236 to perform the tasks of recording audio records and searching the audio records for a match to an audio sample.

As seen in FIG. 5, audio recording subsystem 225 may receive instructions from a user input 248 (e.g. keyboard, mouse) to record calls or audio samples, and to carry out one of the search methods described above. Display 246 may display a list of the calls recorded or logged by recorder 234, as well as relevant call records located by the searches described above. Search results may also be printed, aurally communicated, or output in some other form. An operator who is providing instructions through input 248 and viewing display 246 may be the near-end caller, although this is not necessarily the case.

FIG. 7 shows schematically the data that may be stored in audio repository 240. Two representative file data records 244a, 244b are illustrated, each containing information about a particular call observed on line 205. There may be data fields for the date, time, duration, call type, and caller identification number, as well as for user-provided comments. There may also be a data field for an identification code which uniquely identifies the file data record. If a call was recorded, the audio record of the call may be associated with the file data record corresponding to that call. For example, as shown in FIG. 7, audio record 242a is associated with file data record 244a.

Audio recording subsystem 225 may be configured to perform a method according to the invention. For example, recorder 234 and searcher 236 may be implemented as software 230 contained in a program memory accessible to processor 232. Processor 232 may implement the methods of FIGS. 1, 2 and 3 by executing software instructions provided by software 230. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
Call recording systems may generate recordings of calls involving multiple near-end callers using multiple near-end calling devices on a local network. The search methods described herein may be applied to search collections of such recordings for audio records of interest.
The audio records may comprise calls recorded on a wireless device such as a cellular phone, satellite phone, radio (e.g. police, fire or ambulance mobile radio devices), etc.
The audio records that are searched may comprise records outside of a call recording context, such as a recording of a user dictating or reciting a piece, or a recording of a dialogue or interview between two or more individuals including the user. The methods described herein may be applied to search such audio records for instances wherein a particular word, phrase or other sound is vocalized by the user.
An initial fast correlation may be performed to find potential matches to the audio sample. After potentially relevant matches are located, a finer correlation analysis may be applied to the potentially relevant matches to find more precise matches to the audio sample.
The correlation value may be an adaptive correlation value which adjusts to return an n number of matches. For example, if the correlation value is set too high to find any matches to the audio sample, it may be automatically reduced to find potential matches.
   While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method of searching audio records comprising:
providing a plurality of audio records in which a user is speaking, the plurality of audio records stored on a storage medium;
providing an audio sample of a sound vocalized by the user;
computing a correlation between the audio sample and one or more records of the plurality of audio records;
identifying any records having one or more portions for which the correlation has a correlation value above a threshold value; and
performing at least one of the steps of:
outputting at least a portion of one or more of the identified records; and
storing at least a portion of one or more of the identified records.

2. A method according to claim 1, wherein providing the audio sample comprises recording signals from an input device while the user is vocalizing sound into the input device.

3. A method according to claim 2, comprising recording calls between the user and one or more far-end callers to generate the plurality of audio records for storage on the storage medium.

4. A method according to claim 3, wherein recording calls between the user and one or more far-end callers comprises recording signals from the input device while the user is speaking into the input device during the calls.

5. A method according to claim 2, wherein the input device comprises a telephone handset.

6. A method according to claim 1, wherein computing the correlation between the audio sample and one or more records of the plurality of audio records comprises computing a correlation between the audio sample and incrementally time-shifted portions of each record.

7. A method according to claim 1, comprising determining a relevance rating for each one of the records that are correlated with the audio sample, based at least in part on the correlation value corresponding to the record.

8. A method according to claim 1, wherein outputting the portion of the one or more identified records comprises displaying a list of the identified records.

9. A method according to claim 1, comprising storing copies of the identified records in an audio repository.

10. A method according to claim 1, wherein the sound vocalized by the user comprises a spoken word or phrase.

11. A method of searching audio records comprising:
providing a collection of audio records in which a user is speaking, the collection of audio records stored on a storage medium;
providing an audio sample of a sound vocalized by the user;
selecting one or more records from the collection of audio records for correlation with the audio sample;
computing a correlation between the audio sample and the selected one or more records;
identifying any records having one or more portions for which the correlation has a correlation value above a threshold value; and
performing at least one of the steps of:
outputting at least a portion of one or more of the identified records; and
storing at least a portion of one or more of the identified records.

12. A method according to claim 11, wherein selecting the records from the collection of audio records comprises applying a search parameter to the collection of audio records, the search parameter specifying one or more of the following characteristics of a record:
a date range;
a time range;
a call type;
a call to or from a specified line number;
a call duration; and
a call comment.

13. A method according to claim 12, wherein applying the search parameter to the collection of audio records comprises applying the search parameter to meta-data associated with each record of the collection of audio records.

14. A method according to claim 11, wherein providing the audio sample comprises recording signals from an input device while the user is vocalizing sound into the input device.

15. A method according to claim 14, comprising recording calls between the user and one or more far-end callers to generate the collection of audio records for storage on the storage medium.

16. A method according to claim 15, wherein recording calls between the user and one or more far-end callers comprises recording signals from the input device while the user is speaking into the input device during the calls.

17. A method according to claim 14, wherein the input device comprises a telephone handset.

18. A method according to claim 11, wherein computing the correlation between the audio sample and the selected one or more records comprises computing a correlation between the audio sample and incrementally time-shifted portions of each record.

19. A method according to claim 11, comprising determining a relevance rating for each one of the selected records based at least in part on the correlation value corresponding to the record.

20. A method according to claim 11, wherein the sound vocalized by the user comprises a spoken word or phrase.

21. A method according to claim 11, wherein outputting the portion of the one or more identified records comprises displaying a list of the identified records.

22. A method according to claim 11, comprising storing copies of the identified records in an audio repository.

23. A computer program product comprising a computer readable medium having instructions recorded thereon for execution by a processor to search audio records, the instructions configured to operate the processor to:
retrieve from a storage medium a plurality of audio records in which a user is speaking;
obtain an audio sample of a sound vocalized by the user;
compute a correlation between the audio sample and one or more records of the plurality of audio records;
identify any records having one or more portions for which the correlation has a correlation value above a threshold value; and
perform at least one of the steps of:
outputting at least a portion of one or more of the identified records; and
storing at least a portion of one or more of the identified records.

24. A computer program product according to claim 23, wherein the instructions are configured to operate the processor to generate the audio sample by recording signals from an input device while the user is vocalizing sound into the input device.

25. A computer program product according to claim 24, wherein the instructions are configured to operate the processor to generate the plurality of audio records by recording calls between the user and one or more far-end callers.

26. A computer program product according to claim 25, wherein the instructions are configured to operate the processor to record calls between the user and one or more far-end callers by recording signals from the input device while the user is speaking into the input device during the calls.

27. A computer program product according to claim 23, wherein the instructions are configured to operate the processor to select one or more records of the plurality of audio records for correlation with the audio sample by applying a search parameter to the plurality of audio records, the search parameter specifying one or more of the following characteristics of a record:
a date range;
a time range;
a call type;
a call to or from a specified line number;
a call duration; and
a call comment.

28. A computer program product according to claim 27, wherein the instructions are configured to operate the processor to apply the search parameter to meta-data associated with each record of the plurality of audio records.

29. A computer program product according to claim 23, wherein the instructions are configured to operate the processor to compute the correlation between the audio sample and one or more records of the plurality of audio records by computing a correlation between the audio sample and incrementally time-shifted portions of each record.

30. A computer program product according to claim 23, wherein the instructions are configured to operate the processor to determine a relevance rating for each one of the records that are correlated with the audio sample, based at least in part on the correlation value corresponding to the record.

31. A computer program product according to claim 23, wherein the instructions are configured to operate the processor to display a list of the identified records on a display.

32. A computer program product according to claim 23, wherein the instructions are configured to operate the processor to store copies of the identified records in an audio repository.

33. A system for searching audio records comprising:
an audio recording subsystem operable to generate an audio sample of sound vocalized by a user; and
a search subsystem configured to:
retrieve from a storage medium a plurality of audio records in which the user is speaking;
compute a correlation between the audio sample and one or more records of the plurality of audio records;
identify any records having one or more portions for which the correlation has a correlation value above a threshold value; and
perform at least one of the steps of:
outputting at least a portion of one or more of the identified records; and
storing at least a portion of one or more of the identified records.

34. A system according to claim 33, comprising an input device, wherein the audio recording subsystem is operable to generate the audio sample by recording signals from the input device while the user is vocalizing sound into the input device.

35. A system according to claim 34, wherein the audio recording subsystem is operable to generate the plurality of audio records by recording calls between the user and one or more far-end callers.

36. A system according to claim 35, wherein the audio recording subsystem is operable to record calls between the user and one or more far-end callers by recording signals from the input device while the user is speaking into the input device during the calls.

37. A system according to claim 36, wherein the input device comprises a telephone handset, and the audio sample and the calls are recorded through a microphone of the telephone handset.

38. A system according to claim 34, comprising an encoder coupled to the input device for receiving signals received or transmitted by the input device and encoding the signals as audio and data channel information, wherein the audio recording subsystem is connected to receive and record the audio and data channel information.

39. A system according to claim 33, wherein the search subsystem is operable to select one or more records of the plurality of audio records for correlation with the audio sample by applying a search parameter to the plurality of audio records, the search parameter specifying one or more of the following characteristics of a record:
a date range;
a time range;
a call type;
a call to or from a specified line number;
a call duration; and
a call comment.

40. A system according to claim 39, wherein the search subsystem is operable to apply the search parameter to meta-data associated with each record of the plurality of audio records.

41. A system according to claim 33, wherein the search subsystem is operable to compute the correlation between the audio sample and one or more records of the plurality of audio records by computing a correlation between the audio sample and incrementally time-shifted portions of each record.

42. A system according to claim 33, wherein the search subsystem is operable to determine a relevance rating for each one of the records that are correlated with the audio sample, based at least in part on the correlation value corresponding to the record.

43. A system according to claim 33, comprising a display configured to display the identified records.

44. A system according to claim 33, comprising an audio repository for storing copies of the identified records.

45. A system according to claim 33, comprising an audio playback subsystem for playing back portions of the identified records.

46. A system according to claim 37, comprising an audio playback subsystem for playing back portions of the identified records through a speaker of the telephone handset.

47. A telephone system comprising:
a handset comprising a microphone;
a recording subsystem operable to generate digital sound recordings of calls to which the handset is connected;
a data store capable of storing the digital sound recordings generated by the recording subsystem; and
a search subsystem comprising a processor configured to:
receive and store a sample of sound detected by the microphone;
compute a correlation between the sample and one or more of the digital sound recordings;
identify any recordings having one or more portions for which the correlation has a correlation value above a threshold value; and
perform at least one of the steps of:
outputting at least a portion of one or more of the identified records; and
storing at least a portion of one or more of the identified records.

48. A telephone system according to claim 47, comprising an encoder coupled to the handset for receiving signals received or transmitted by the handset and encoding the signals as audio and data channel information, wherein the recording subsystem is connected to receive and record the audio and data channel information.

49. A telephone system according to claim 47, wherein the search subsystem is operable to select one or more of the digital sound recordings for correlation with the sample by applying a search parameter to the digital sound recordings, the search parameter specifying one or more of the following characteristics of a recording:
a date range;
a time range;
a call type;
a call to or from a specified line number;
a call duration; and
a call comment.

50. A telephone system according to claim 49, wherein the search subsystem is operable to apply the search parameter to meta-data associated with each recording.

51. A telephone system according to claim 47, wherein the search subsystem is operable to compute the correlation between the sample and one or more of the digital sound recordings by computing a correlation between the sample and incrementally time-shifted portions of each recording.

52. A telephone system according to claim 47, wherein the search subsystem is operable to determine a relevance rating for each one of the recordings that are correlated with the sample, based at least in part on the correlation value corresponding to the recording.

53. A telephone system according to claim 47, comprising a display configured to display the identified recordings.

54. A telephone system according to claim 47, comprising an audio repository for storing copies of the identified recordings.

55. A telephone system according to claim 47, comprising an audio playback subsystem for playing back portions of the identified recordings.

56. A telephone system according to claim 55, wherein the audio playback subsystem is configured to play back portions of the identified recordings through a speaker of the handset.
